(19) United States
(12) Patent Application Publication
(10) Pub. No.: US 2013/0135567 A1
(43) Pub. Date: May 30, 2013

(54) COLOR FILTER SUBSTRATE AND LIQUID CRYSTAL DISPLAY PANEL USING THE SAME

(71) Applicants: DONGGUAN MASSTOP LIQUID CRYSTAL DISPL, Dongguan City (CN); WINTEK CORPORATION, Taichung City (TW)

(72) Inventors: Chien-Chang Lee, Madou Township (TW); Yi-Chun Wu, Hualien City (TW); Wei-Chih Hsu, Taichung City (TW)

(73) Assignees: WINTEK CORPORATION, Taichung City (TW); DONGGUAN MASSTOP LIQUID CRYSTAL DISPLAY CO., LTD., Dongguan City (CN)

(21) Appl. No.: 13/681,940

(22) Filed: Nov. 20, 2012

(30) Foreign Application Priority Data
Nov. 24, 2011 (TW) 100143205

(51) Int. Cl. G02F 1/1335; G02B 5/23

(52) U.S. Cl. CPC G02F 1/133514; G02B 5/23
USPC 349/106; 359/885

(57) ABSTRACT

A color filter substrate including a substrate, several color filter units and a filter block with at least one kind of color is provided. The substrate at least has a first area, a second area, a third area and a combined area. The color filter units are respectively disposed on the first area, the second area and the third area according to their colors. The filter block with at least one kind of color is disposed on combined area according to a certain percentage or a certain combination to increase the area of the color filter units with the same color.

This application claims the benefit of Taiwan application Serial No. 100143205, filed Nov. 24, 2011, the subject matter of which is incorporated herein by reference.

### BACKGROUND OF THE INVENTION

1. Field of the Invention

The invention relates in general to a display device, and more particularly to a color filter substrate and a liquid crystal display (LCD) panel using the same.

2. Description of the Related Art

With the features of slimness, lightweight and power saving, the liquid crystal display (LCD) panel has gained great popularity. Basically, an LCD is equipped with color filter substrates, such as red, green, blue (RGB) filter substrates. As the users demand the LCD to have better performance in terms of brightness and power saving, the RGBW LCD is thus provided. In an RGBW LCD, a transparent area is added to the sub-pixel of the color filter array to increase the transmittance of the light and reduce the power consumed by the light source of the display panel.

However, the RGBW LCD normally has problems with white balance. Referring to Table 1, data regarding white display CIE chromaticity coordinates and transmittance of a conventional RGB LCD and an RGBW LCD are respectively shown.

TABLE 1

| | White Display CIE | | Standard | |
|---|---|---|---|---|
| | Chromaticity Coordinates | | Error | Transmittance |
| | x | y | Δxy | (%) |
| RGB type | 0.286 | 0.3064 | 0 | 100% |
| RGBW type | 0.2936 | 0.3046 | 0.00781 | 158% |

In terms of white display CIE chromaticity coordinates, the RGBW LCD differs with the conventional RGB LCD significantly no matter in the x or the y chromaticity coordinate, and the overall color turns yellowish and cannot achieve the chromaticity range required by the RGB LCD.

Moreover, the RGBW LCD, having an extra sub-pixel (W pixel) than the conventional RGB LCD, requires an extra process of adding mask to the transparent block and extra driving elements (such as driving lines and thin film transistors). Furthermore, if the area ratio among the R, G, B, W pixels varies, the area that the thin film transistors need to drive would be different from the original design, and problems such as insufficient driving capacity and signal decay would occur.

### SUMMARY OF THE INVENTION

The invention is directed to a color filter substrate and a liquid crystal display (LCD) panel using the same. A filter block of certain percentage is disposed on the area corresponding to the W pixels, so as to achieve the chromaticity range requested by the RGB LCD.

According to an embodiment of the present invention, a color filter substrate including a substrate, several color filter units and a filter block with at least one kind of color is provided. The substrate at least has a first area, a second area, a third area and a combined area. The color filter units are respectively disposed on the first area, the second area and the third area according to their colors. The filter block with at least one kind of color is disposed on the combined area according to a certain percentage or a certain combination to increase the area of the color filter units with the same color.

According to another embodiment of the present invention, an LCD including a pixel array substrate, a color filter substrate and a liquid crystal layer is provided. The liquid crystal layer is disposed between the pixel array substrate and the color filter substrate. The color filter substrate includes a substrate, several color filter units and a filter block with at least one kind of color. The substrate at least has a first area, a second area, a third area and a combined area. The color filter units are respectively disposed on the first area, the second area and the third area according to their colors. The filter block with at least one kind of color is disposed on the combined area according to a certain percentage or a certain combination to increase the area of the color filter units with the same color.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIGS. 1A and 1B respectively show an LCD and a color filter substrate inside the LCD according to an embodiment of the invention; and

FIG. 2 shows a CIE chromaticity diagram.

### DETAILED DESCRIPTION OF THE INVENTION

A color filter substrate and a liquid crystal display (LCD) panel using the same are disclosed in the present embodiment. Ordinary manufacturing process and mask design can be used for manufacturing the color filter substrate, and a certain percentage of the area of the combined area corresponding to the W pixels is occupied by a filter block. The filter block is exemplified by a red block, a blue block, a green block or a combination of any two type of the above blocks, and each filter block occupies 10˜50% of the area of the combined area. For example, the mask has a special pattern design, and the filter blocks with two kinds of colors (such as a blue block occupying 25.9% of the area of the combined area and a green block occupying 24% of the area of the combined area) are coated on the combined area corresponding to the W pixels. Referring to Table 2, data regarding white display CIE chromaticity coordinates and transmittance of a conventional RGB LCD and a corrected RGBW LCD of the present embodiment are respectively shown.

TABLE 2

| | White Display CIE | | Standard | |
|---|---|---|---|---|
| | Chromaticity coordinate | | Error | Transmittance |
| | x | y | Δxy | (%) |
| RGB LCD | 0.286 | 0.3064 | 0 | 100% |
| Corrected RGBW | 0.2864 | 0.3073 | 0.000985 | 132% |
| LCD | | | | |

In terms of the white display CIE chromaticity coordinates, the corrected white display CIE chromaticity coordinates of the present embodiment being (0.2864,0.3073) are significantly close to the white display CIE chromaticity coordinates of the conventional RGB LCD being (0.286,0.3064), and the transmittance is increased by more than 30%. In comparison, the color filter substrate and the LCD using the same of the present embodiment have superior white balance and higher transmittance, so as to achieve the chromaticity range requested by the conventional RGB LCD.

A number of embodiments are disclosed below for elaborating the invention. However, the embodiments of the invention are for detailed descriptions only, not for limiting the scope of protection of the invention.

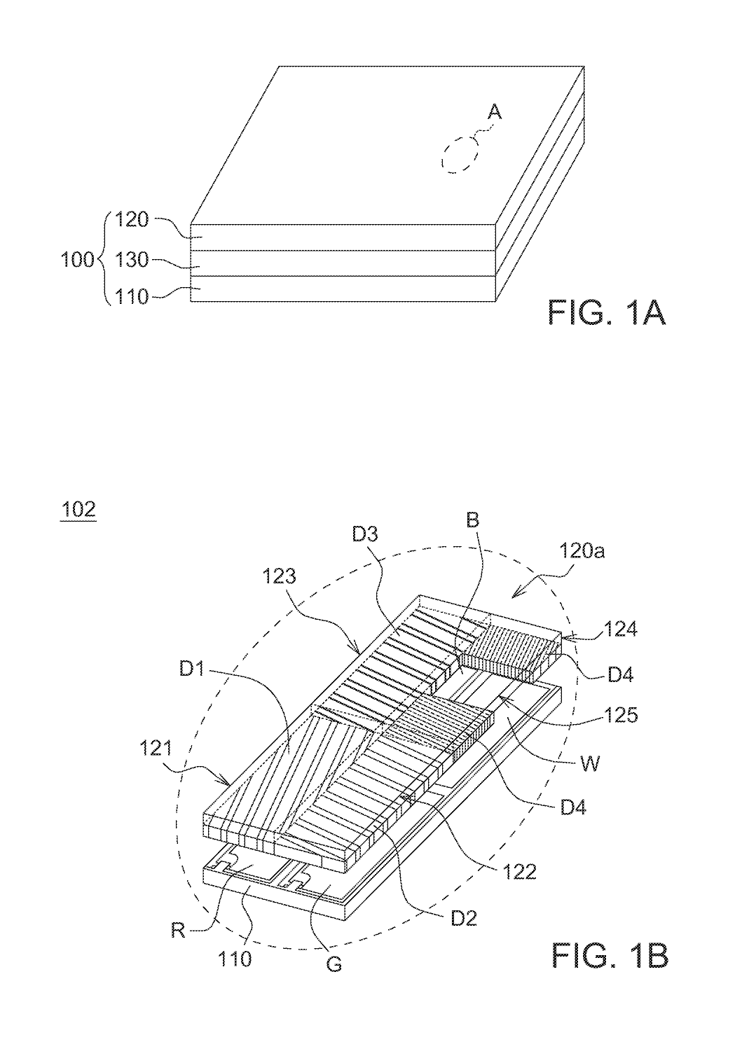

Referring to FIGS. 1A and 1B, an LCD and a color filter substrate inside the LCD according to an embodiment of the invention are respectively shown. The LCD 100 has several pixel units. In the present embodiment, the pixel units are exemplified by one single pixel unit 102 positioned in the region A of the LCD 100. As indicated in FIGS. 1A and 1B, the LCD 100 includes a pixel array substrate 110, a color filter substrate 120 and a liquid crystal layer 130. The liquid crystal layer 130 is disposed between the pixel array substrate 110 and the color filter substrate 120. The color filter substrate 120 includes a substrate 120a, several color filter units D1˜D3 and a filter block with at least one kind of color D4. The color filter units can include a first color filter unit D1, a second color filter unit D2 and a third color filter unit D3, wherein the color filter units D1˜D3 have different colors, and may be realized by a red photo-resist, a blue photo-resist and a green photo-resist, for example. Additionally, the color filter units D1˜D3 may also be realized by such as a cyan photo-resist, a magenta photo-resist and a yellow photo-resist according to the subtractive color model for absorbing the wavelengths of the visible light including the red, the green and the blue light, so as to achieve the same light mixing effect like the red, the blue and the green photo-resists. Examples of the color filter units D1˜D3 include pigment, dye and optical filter film in addition to the above-mentioned photo-resist. Therefore, it is not limited to the material of the color filter units D1˜D3.

The pixel array substrate 110 such as a pixel array substrate equipped with a thin film transistor is used for driving the liquid crystal molecules of the liquid crystal layer 130 to change the luminance state of the light penetrating the liquid crystal layer, so as to display contrast effect. The color filter substrate 120 is disposed on the liquid crystal layer 130 for changing the colors of the light so as to display a full-color frame.

In the single pixel unit 102 of the region A, the substrate 120a at least has a first area 121, a second area 122, a third area 123 and a combined area 124. The combined area 124 corresponds to the position of the W pixels, so that the filter block D4 with at least one kind of color is correspondingly positioned on the W pixels, so that the area of the color filter units with the same color is increased. Besides, the color filter units D1˜D3 are respectively disposed on the first area 121, the second area 122 and the third area 123 according to their colors. The first area 121, the second area 122 and the third area 123 respectively correspond to the positions of the RGB pixels, such that the color filter units with different colors are correspondingly positioned on the RGB pixels. Therefore, the light passing through the color filter units D1˜D3 will be converted to RGB lights which enable the LCD 100 to display a full-color frame.

The above disclosure indicates that when the area percentage of the filter block D4 to the combined area 124 varies, the white display CIE chromaticity coordinates and the transmittance of the LCD 100 will vary accordingly. In an embodiment, the combined area 124 can include a transparent area 125. The light may pass through the transparent area 125 directly without being converted into RGB lights, so that the transmittance of the light is increased and the power consumed by the light source of the panel is reduced. The transparent area 125 occupies 10˜50% of the area of the combined area 124, wherein the percentage range may be increased or decreased according to actual needs in the transmittance of the light, and the invention is not limited thereto.

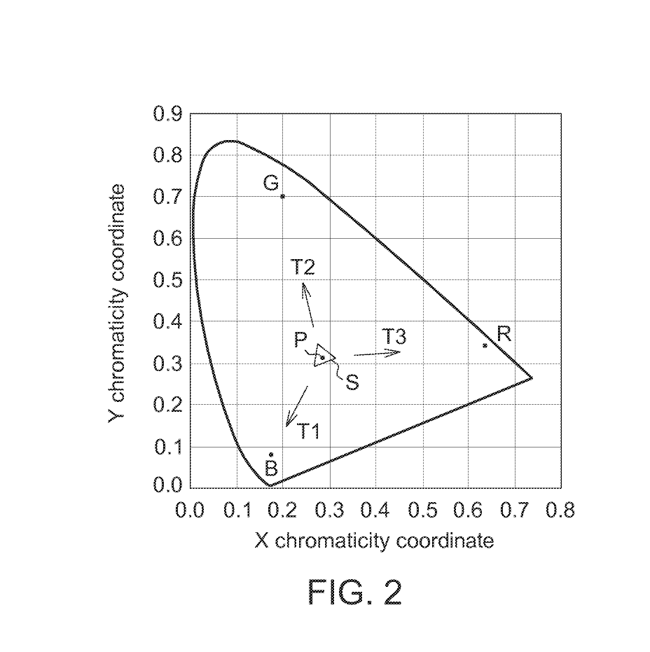

Referring to FIG. 2, a CIE chromaticity diagram is shown. In the present embodiment, the white display CIE chromaticity coordinates of the RGBW LCD before correction are (0.2936, 0.3046). When only the blue (B) block is disposed on the combined area 124 and the area percentage of the blue block to the combined area is increased, the chromaticity coordinate P will move along an arrow direction T1, making the x and the y chromaticity coordinates both become smaller. When only the green (G) block is disposed on the combined area 124 and the area percentage of the green block to the combined area is increased, the chromaticity coordinate P will move along an arrow direction T2, making the x chromaticity coordinate become smaller but the y chromaticity coordinate become larger. When only the red (R) block is disposed on the combined area 124 and the area percentage of the red block to the combined area is increased, the chromaticity coordinate P will move along an arrow direction T3, making the x chromaticity coordinate become larger but the y chromaticity coordinate become smaller.

Similarly, when the filter block D4 with two kinds of colors is disposed on the combined area 124, the moving direction of the chromaticity coordinate P may be estimated according to the area percentage of the filter block D4. For example, when the blue and the green blocks are disposed on the combined area 124 and respectively occupying certain percentages of the area of the combined area 124, the chromaticity coordinate P will move along a direction within a chromaticity range contained by the arrow directions T1 and T2. By the same token, the chromaticity ranges of the chromaticity coordinate P when the blue and the red blocks or the red and the green blocks are disposed on the combined area may be obtained respectively, and a chromaticity variation region S distributed in a triangular shape as indicated in FIG. 2 is obtained.

Referring to Table 3, data regarding CIE chromaticity coordinates and filter block percentages according to an embodiment of the invention are shown.

TABLE 3

| Area Percentage (%) | | |
|---|---|---|
| B: Blue Block | | |
| G: Green Block | X | Y |
| B 45% | 0.2811 | 0.2883 |
| B 35% | 0.2884 | 0.2963 |
| B 30% | 0.2914 | 0.2997 |
| B 35%, G 17% | 0.2876 | 0.2983 |
| B 35%, G 20% | 0.2866 | 0.3009 |
| B 40%, G 24% | 0.2829 | 0.3037 |
| B 25.9%, G 24% | 0.2864 | 0.3073 |
| B 24%, G 24% | 0.2869 | 0.3078 |

In the above data, the CIE chromaticity coordinate varies with the change in the area percentage of the filter block D4. Therefore, the white display CIE chromaticity coordinates of RGBW LCD may be corrected from (0.2936, 0.3046) to (0.2864, 0.3073), which are closer to the target chromaticity coordinates (0.286, 0.3064), so as to achieve the chromaticity range requested by the RGB LCD.

According to the color filter substrate and the LCD using the same disclosed in the above embodiments of the invention, a filter block is disposed on the combined area corresponding to the W pixel to a certain percentage to increase the area of the color filter unit with the same color. Therefore, under the existing manufacturing process and mask design, the CIE chromaticity coordinates of the RGBW LCD are adjusted and the transmittance of the light is increased without increasing the mask process for the transparent area. Furthermore, respective RGBW pixel areas of the LCD are not changed and remain consistent with the original design and can thus be driven by the thin film transistors, hence avoiding problems such as insufficient driving capacity and signal decay.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A color filter substrate, comprising:
a substrate at least having a first area, a second area, a third area and a combined area;
a plurality of color filter units respectively disposed on the first area, the second area and the third area according to their colors; and
a filter block with at least one kind of color disposed on the combined area according to a certain percentage or a certain combination to increase the area of the color filter units with the same color.

2. The color filter substrate according to claim 1, wherein the combined area comprises a transparent area.

3. The color filter substrate according to claim 2, wherein the transparent area occupies 10˜50% of the area of the combined area.

4. The color filter substrate according to claim 1, wherein the color filter units comprise a red color filter unit, a blue color filter unit and a green color filter unit.

5. The color filter substrate according to claim 1, wherein in the combined area, the filter block with at least one kind of color comprises a red block, a blue block, a green block or a combination of any two type of the above blocks.

6. The color filter substrate according to claim 1, wherein in the combined area, the filter block with any one kind of color occupies 10˜50% of the area of the combined area.

7. The color filter substrate according to claim 6, wherein in the combined area, the filter block with any one kind of color occupies 20˜40% of the area of the combined area.

8. A liquid crystal display (LCD) panel, comprising:
a pixel array substrate;
a color filter substrate, comprising:
a substrate at least having a first area, a second area, a third area and a combined area;
a plurality of color filter units respectively disposed on the first area, the second area and the third area according to their colors; and
a filter block with at least one kind of color disposed on the combined area according to a certain percentage or a certain combination to increase the area of the color filter units with the same color; and
a liquid crystal layer disposed between the pixel array substrate and the color filter substrate.

9. The LCD according to claim 8, wherein the combined area comprises a transparent area.

10. The LCD according to claim 9, wherein the transparent area occupies 10˜50% of the area of the combined area.

11. The LCD according to claim 8, wherein the color filter units comprise a red color filter unit, a blue color filter unit and a green color filter unit.

12. The LCD according to claim 8, wherein in the combined area, the filter block with at least one kind of color comprises a red block, a blue block, a green block or a combination of any two types of the above blocks.

13. The LCD according to claim 8, wherein in the combined area, the filter block with any one kind of color occupies 10˜50% of the area of the combined area.

14. The LCD according to claim 13, wherein in the combined area, the filter block with any one kind of color occupies 20˜40% of the area of the combined area.
